(19) United States
(12) Patent Application Publication
(10) Pub. No.: US 2005/0223662 A1
(43) Pub. Date: Oct. 13, 2005

(54) Apparatus and method for installing and anchoring an insert into a structure

(76) Inventor: Bruce K. Greene, Bellevue, WA (US)

Correspondence Address: DARBY & DARBY P.C., P. O. BOX 5257, NEW YORK, NY, 10150-5257, US

(21) Appl. No.: 11/139,082

(22) Filed: May 27, 2005

Related U.S. Application Data
(60) Provisional application No. 60/624,730, filed on Nov. 2, 2004.

(51) Int. Cl. E06B 3/00

(52) U.S. Cl. 52/204.55

(57) ABSTRACT

A bracket and a method for installing and anchoring an insert, such as a window, within a frame that forms an opening in a structure. The bracket includes a formed end shaped with a channel to fit over a flange at an outer periphery of the insert. The flange can move within the channel to accommodate motion of the structure. A bracket shank extends from the formed end to fit between a casing of the insert and the frame. A bracket fastener end extends from the shank, and includes one or more holes through which fasteners can attach the bracket to the frame. A number of brackets are placed over the flange of the insert, which may be placed within the opening from the inside of the structure. The insert may be temporarily fastened to the frame, adjusted to a desired position, and then permanently anchored to the frame.

### CROSS-REFERENCE TO RELATED APPLICATIONS

This utility application claims the benefit of U.S. Provisional Patent Application 60/624,730 filed Nov. 2, 2004; the contents of which is hereby incorporated by reference.

### FIELD OF THE INVENTION

The present invention is directed to an insert installation, and more specifically to a bracket and a method for installing and anchoring an insert, such as a window, from within a structure.

### BACKGROUND OF THE INVENTION

Windows, window fans, and other inserts for houses and other structures have typically been installed from outside the structure. This is especially true for windows that include a nail fin (sometimes called a nail flange) or other conventional flange around the perimeter of the window for attaching the window to a frame that forms a window opening in the structure. Generally, the window is placed into the frame such that the nail fin butts against an outer surface of the frame. Nails are usually driven through the nail fin from outside the structure and into the frame of the structure to hold the window in place. External waterproofing and wall siding material is typically placed over the nail fin to cover the nail fin and nails.

This external nailing technique generally keeps the window secure and is an easy technique for installing and anchoring windows on low buildings. However, taller buildings normally require scaffolding, extra safety precautions, and additional time to install windows in the same way. The external nailing technique can also make the nail fin and overall window susceptible to cracking, deformation, and leaking as the structure settles or is moved by an earthquake. Settling can be addressed to some degree by omitting nails through the nail fin across the top of the window. Accordingly, nailing the top of the window generally voids most manufacturers' warranties, and is not performed. However, omitting nails does not anchor the entire window, which makes it easier for the window to blow out under air pressure, to vibrate, and to break seals. Nailing through the nail fin and into the frame of the structure also introduces moisture paths that may require additional sealing to prevent moisture damage. Damage to the nail fin and/or window glass can result from workmen missing their mark while hammering. Nails through the nail fin also generally minimize or eliminate the ability to later adjust the window location and/or the ability of the window material to expand or contract with temperature changes.

Some attempts have been made at alternate ways to install and/or anchor a window. These attempts generally require that the outer perimeter of the window casing be configured in a particular way, such as a stepped configuration or a channel configuration. These special configurations generally add complexity and cost to the window.

### BRIEF DESCRIPTION OF THE DRAWINGS

FIG. 1 is an external view illustrating a window partially inserted into a frame of a structure with an exemplary bracket embodiment of the present invention;

FIG. 2 is an internal view illustrating the window installed into the frame of the structure with an exemplary bracket embodiment of the present invention;

FIG. 3 is a sectional view of the window secured to the frame by an exemplary bracket embodiment;

FIG. 4A is an isometric view of an exemplary bracket embodiment of the present invention;

FIG. 4B is a top view of an exemplary bracket embodiment of the present invention;

FIG. 4C is a side view of an exemplary bracket embodiment of the present invention;

FIG. 4D is a front view of an exemplary bracket embodiment of the present invention; and

FIG. 5 is a flow diagram illustrating exemplary logic for installing a window according to the present invention;

### DETAILED DESCRIPTION OF THE INVENTION

The present invention provides an apparatus and method to install and anchor a window, a sliding glass door, or other insert from within a structure without requiring a special configuration of the insert. In general, the present invention includes a bracket with an outer formed end that is shaped to fit over a flange of an insert. The bracket also has an inner fastener end that is fastened to a frame that forms an opening in the structure. The insert can be installed into the frame opening to temporarily maintain the insert in the opening, so that the insert can be shimmed, aligned, or otherwise adjusted. The fastener end of the bracket is attached to the frame to permanently anchor the insert to the structure. The following exemplary embodiment is described in terms of installing and anchoring a window, but the invention is not limited to such embodiment.

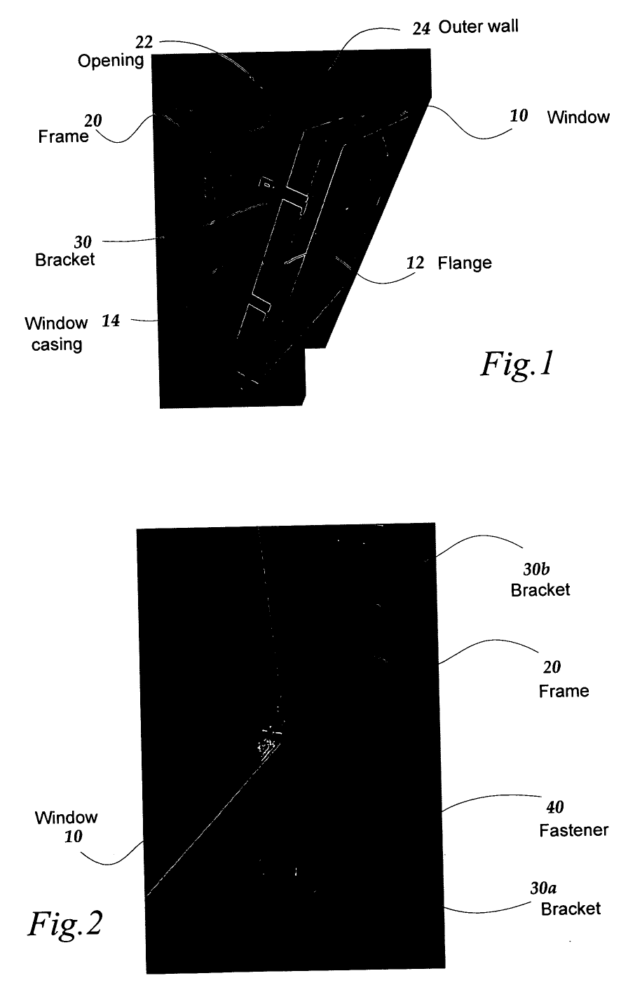

FIG. 1 is a view from outside a structure illustrating a window 10 partially inserted into a frame 20 of a structure with an exemplary bracket 30 of the present invention. Multiple brackets 30 are slipped over a flange 12 that surrounds window 10. A flat portion of the brackets extend parallel to a perimeter surface of a window casing 14. Generally, window casing 14 and brackets 30 are inserted into an opening 22 formed by frame 20. As window 10 is inserted into opening 22, flange butts against frame 20 or against an outer wall 24 if frame 20 is covered by outer wall 24.

FIG. 2 is view from within a structure illustrating window 10 installed into frame 20 of the structure. Exemplary brackets 30a and 30b are adjacent to an inner surface of frame 20. Fasteners, such as fastener 40 attach the brackets to frame 20. The fasteners can be nails, screws, staples, rivets, and the like. Alternatively, the brackets can be bonded to the frame with an adhesive.

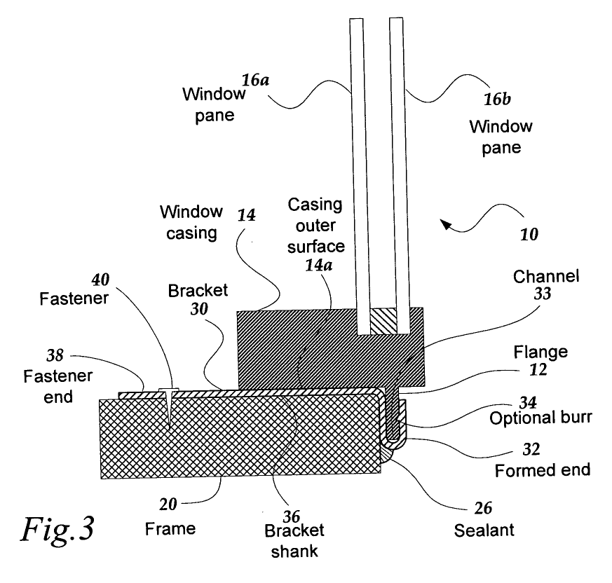

FIG. 3 is a sectional view of window 10 secured to frame 20 by exemplary bracket 30. A formed end 32 of bracket 30 includes a channel 33 that fits over flange 12. If desired, an optional burr 34 of bracket 30 can be used to grip flange 12, keeping formed end 32 in place. Formed end 32 is formed to fit over flange 12 such that a portion of formed end 32 fits between flange 12 and frame 20 (or between the flange and the outer wall if an outer wall covers frame 20). A bracket shank 36 is formed to fit between window casing 14 and frame 20. Bracket shank 36 may extend generally parallel to an outer surface 14a of window casing 14. Bracket shank 36 may also extend generally perpendicular to a longitudinal axis of channel 33, which may also be generally perpendicular to flange 12 and a primary surface of window 10, such as perpendicular to window panes 16a and 16b. A fastener end 38 of bracket 30 extends beyond window casing 14 such that fastener end 38 is accessible from within the structure. Fastener 40 is driven through a slot in fastener end 38 to secure bracket 30 to frame 20, thereby anchoring window 10. An external sealant 26, such as a silicone caulk, can also be applied around the perimeter of flange 12 and over formed end 32 of bracket 30. Similarly, an internal sealant can be applied around the inner perimeter of window casing 14. A finishing material, such as a waterproofing paper and wood molding (not shown), can be applied over fastener end 38 and attached to frame 20 to hide bracket 30.

To form bracket 30, one or more tools may be shaped similar to flange 12, window casing 14, and/or frame 20. For example, A top tool, shaped similar to flange 12 and window casing 14 can be used to stamp a flat stock into shape over one or more bottom tools, shaped similar to frame 20 (e.g., one bottom tool with a slot or two bottom tools spread apart to enable formed end 32 to be stamped into shape). Fastener holes can also be stamped into bracket 30 during the forming operation. Alternatively, a flat stock can be bent around a forming tool shaped similar to flange 12 and window casing 14. As another alternative, bracket 30 may be molded by in or around one or more tools that are shaped similar to flange 12, window casing 14, and/or frame 20.

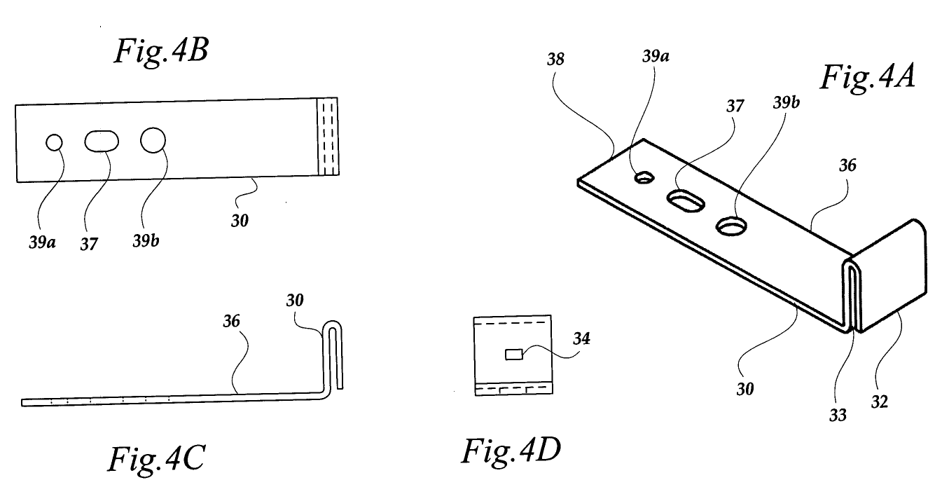

FIG. 4A is an isometric view of bracket 30. Bracket 30 can comprise a metal, a plastic, a composite and/or other relatively rigid material. For pliable materials, such as metal, bracket 30 and be extruded into a formed shape, and then drilled or punched. Alternatively, racket 30 can be formed from a flat stock approximately one inch wide and approximately 6 inches long. One end of the flat stock is bent to produce formed end 32 that comprises channel 33 to be placed over the flange. The channel can be approximately one inch deep, making the formed bracket approximately 4 inches long. A slot 37 and/or one or more holes 39a and 39b are cut or punched through fastener end 38. The holes and/or slot can be created prior to, or after producing formed end 32. To change material characteristics, such as hardness, yield strength, corrosion resistance, and the like, bracket 30 can be treated with heat, pressure, coatings, and the like. For additional corrosion resistance or other reasons, bracket 30 can be injection molded, blow molded, heat pressed, or otherwise molded from a plastic or composite material to produce formed end 32, shank 36, and fastener end 38. Slot 37 and/or holes 39a and 39b can then be drilled into the molded work piece.

FIG. 4B is a top view of bracket 30 illustrating fastener slot 37. Slot 37 is sized for a desired fastener type and may be chamfered or recessed, so that a fastener head will be level with an upper surface of bracket 30. Slot 37 may be oriented longitudinally (as shown) or transversely (not show) to enable the bracket to be repositioned during installation. Similarly, one or more holes, such as holes 39a and 39b, may be chamfered or recessed. The additional hole(s) may be used with an additional fastener to prevent bracket 30 from sliding, rotating, or otherwise moving relative to the frame after one fastener is installed through slot 37. In addition, or alternatively, one or more pilot holes or dimples can be provided, so that a fastener can be driven through bracket 30.

FIG. 4C is a side view of bracket 30. Bracket shank 36 is illustrated as flat, but can be formed to conform to the shape of any window casing (or the casing of any other type of insert). For example, shank 36 can be formed in an angled fashion, a stepped fashion, a curved fashion, or other configuration to conform to the casing of an insert. If the casing and the structure frame do not have a matching configuration, such that a gap results between a portion of the casing and a portion of the frame, shank 36 can be formed to provide additional support between the insert casing and the frame structure. For instance, shank 36 can be have a hat shape, a corrugated shape, a curved shape, and/or other shape that provides support and/or spring flexibility. In addition, or alternatively, shims, blocks, or other supports can be used to fill gaps between the insert casing and frame of the structure.

FIG. 4D is a front view of bracket 30. Formed end 32 can optionally be punched or otherwise modified to form a burr 34 within the channel.

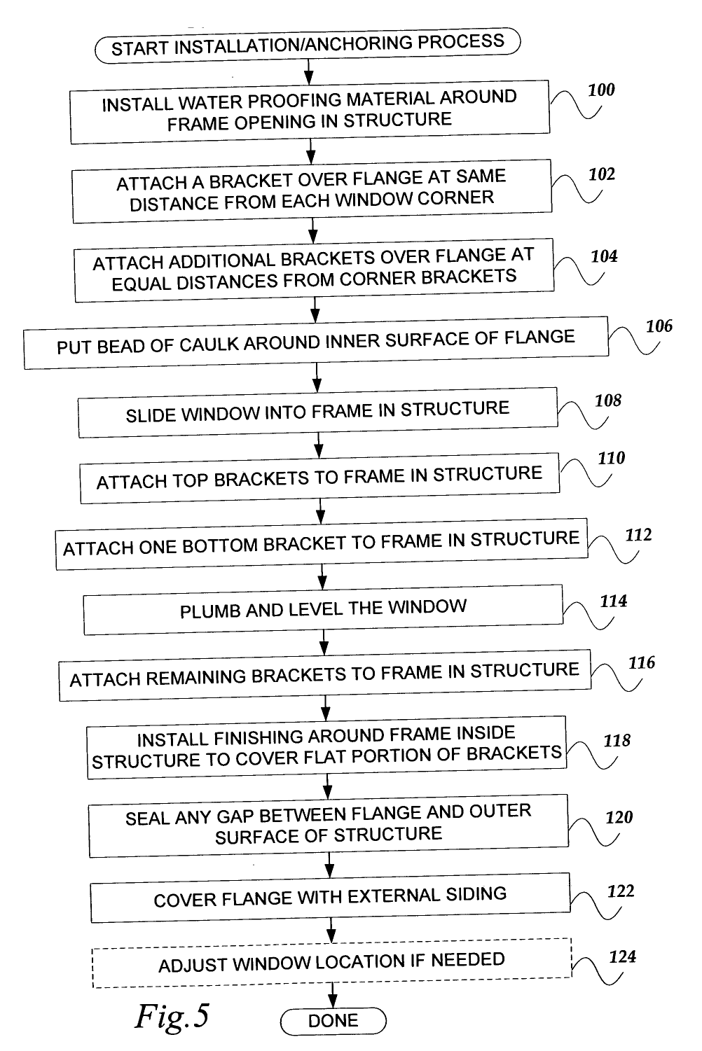

FIG. 5 is a flow diagram illustrating exemplary logic for installing an insert, such as a window, according to the present invention. Generally, an installer prepares the frame of the structure, puts a number of brackets over the window flange, moves the window into the frame opening, and fastens the brackets to the frame of the structure. One or more suction cups can be used to assist with positioning the window in the frame opening. A more detailed example is described below.

At an operation 100, an installer may optionally apply caulk, water proofing material and/or other sealant or adhesive to the frame that forms the opening in the structure. The sealant may be applied to one or more surfaces of the frame, including an interior surface of the frame against which the window casing will interface. At an operation 102, an initial set of brackets are fit onto the flange at approximately equal distances from each corner of the flange. The formed end of each bracket is fit onto the flange, and may be held in place by friction fit, by the optionally punched burr, by an adhesive, and/or other means of holding the bracket in place on the flange. The initial set of brackets at the corners may provide reference points for other brackets. Alternatively, or in addition, the window may be temporarily installed into the frame opening with the initial set of brackets to test clearances, alignment, and/or other aspects. At an operation 104, additional brackets, as desired, are fit onto the flange at approximately equal distances from the corner brackets.

At an operation 106, a beak of caulk or other sealant may be applied to an inner surface of the flange, which will be placed against on outer surface of the frame and/or outer wall surface of the structure. This operation may be done at a later time after the window is temporarily installed to check for alignment and/or other aspects.

With or without sealant, the window is slid into the opening formed by the frame at an operation 108. At an operation 110, brackets that are fit onto the flange at a top of the window are temporarily fastened or otherwise attached to a top portion of the frame. For example, a nail may be partially driven through a hole in the fastener end of the brackets and into the frame. One bracket that is fit onto the flange at a bottom portion of the window is temporarily attached to a bottom portion of the frame, at an operation 112. At an operation 114, the window is plumbed and leveled. This may include shimming, bracing, aligning, or otherwise orienting the window to a desired position. The temporarily attached brackets can then be attached to the frame with screws and/or other permanent fasteners. Similarly, the remaining brackets are permanently attached to the frame to anchor the window, at an operation 116. At an operation 118, a decorative molding or other finishing materials may be installed over the fastener ends of the brackets and attached to the internal surface of the frame.

A sealant can be applied around an outer edge of the flange, at an operation 120, to seal any gap between the flange and an outer surface of the frame and/or structure. The flange can be covered with external siding or other finishing material at an operation 122. Because the formed end of the brackets are not fastened to the flange with a fastener, the window position can still be adjusted if desired, at an optional operation 124. This may be done intentionally to adjust the orientation or other aspect of the window right after installation, and/or at a later time. This may also be done as a matter of course, if the structure settles, if an earthquake occurs, and/or for other reasons.

The above specification, examples, and information provide a complete description of the design, manufacture, and use of the invention. For example, the bracket can be sized to fit over various sizes of flanges, and the shank portion can be sized to fit within various frame sizes. The bracket and/or method described above can be used for other inserts, such as sliding glass doors, garden windows, window fans, air conditional units, or other inserts that include a peripheral flange. Since many embodiments of the invention can be made without departing from the spirit and scope of the invention, the invention resides in the claims hereinafter appended.

1. A bracket for installing and anchoring an insert, comprising:
a formed end shaped into a channel to fit over a flange at a periphery of an insert;
a shank extending from the formed end; and
a fastener end extending from the shank, wherein the fastener end includes a hole for a fastener to fasten the fastener end to a frame that forms an opening in a structure.

2. The bracket of claim 1, wherein the bracket comprises one of the following materials; a metal, a plastic, and a composite.

3. The bracket of claim 1, wherein the channel is sized to provide a friction fit with the flange.

4. The bracket of claim 1, wherein the channel is sized to enable movement of the insert relative to the bracket.

5. The bracket of claim 1, wherein the formed end includes a burr within the channel to hold the bracket to the flange.

6. The bracket of claim 1, wherein the shank extends in a direction that is substantially perpendicular to a longitudinal axis of the channel.

7. The bracket of claim 1, wherein the shank is one of the following:
substantially flat;
shaped to follow a contour of a casing of the insert; and
shaped to provide support between the casing of the insert and the frame.

8. The bracket of claim 1, wherein the fastener end extends from the shank by a distance that enables the hole in the fastener end to extend beyond a casing of the insert and within a width of an inner surface of the frame.

9. The bracket of claim 1, wherein the hole in the fastener end comprises a slot.

10. The bracket of claim 1, wherein the fastener end includes an additional hole for an additional fastener to fasten the fastener end to the frame so that the bracket remains in a fixed position relative to the frame.

11. A method for installing and anchoring an insert, comprising:
placing a plurality of brackets around a periphery of the insert, wherein a formed end of each of the plurality of brackets is placed over a flange at the periphery of the insert, and wherein the formed end of each of the plurality of brackets is shaped with a channel such that the flange is fit within the channel;
inserting the insert and the plurality of brackets into a frame that forms an opening in a structure; and
fastening a fastener end of each of the plurality of brackets to the frame.

12. The method of claim 1, wherein the insert comprises one of the following; a window, a door, a fan, and an air conditioning unit.

13. The method of claim 1, wherein inserting the insert is performed from within the structure.

14. The method of claim 1, further comprising coupling at least one suction cup to the insert to assist in inserting the insert into the frame.

15. The method of claim 1, wherein fastening comprises one of the following:
temporarily fastening to enable adjusting a position of the insert within the opening; and
permanently fastening to anchor the insert.

16. The method of claim 1, further comprising adjusting a position of the insert in response to a movement of the structure.

17. The method of claim 1, wherein the plurality of brackets include a shank that is one of the following:
substantially flat;
formed to a contour of a casing of the insert; and
formed to provide a support between the insert and the frame.

18. The method of claim 1, further comprising applying a sealant to at least one of the insert and the frame to seal an interface between the insert and the frame.

19. The method of claim 1, further comprising installing a finishing material over at least one of the following:
the fastener end of each of the plurality of brackets; and
the formed end of each of the plurality of brackets.

20. A tool for forming a bracket of claim 1.
